(19) United States
(12) Patent Application Publication
(10) Pub. No.: US 2009/0114305 A1
(43) Pub. Date: May 7, 2009

(54) CORROSION RESISTANT SHEET METAL JACKETING

(75) Inventors: James M. Roberts, Houston, TX (US); Michael Starozhitsky, Long Grove, IL (US); Andrea C. McMartin, Evanston, IL (US)

Correspondence Address: Levenfeld Pearlstein, LLC (ILLINOIS TOOL WORKS), 2 North LaSalle Street, Suite 1300, Chicago, IL, 60602, US

(73) Assignee: Illinois Tool Works, Inc., Glenview, IL (US)

(21) Appl. No.: 11/934,224

(22) Filed: Nov. 2, 2007

(51) Int. Cl. F16L 9/00; B21D 51/00

(52) U.S. Cl. 138/143; 29/428; 138/146; 138/149

(57) ABSTRACT

A corrosion resistant jacket for insulated pipes comprising an outer polymeric layer, an inner polymeric layer, and a sheet metal layer disposed between the outer and the inner polymeric layers. Also disclosed is a method of making a corrosion resistant sheet metal jacket.

### BACKGROUND OF THE INVENTION

The present invention is directed to an insulated pipe jacket. More particularly, the present invention pertains to a layered, corrosion resistant sheet metal jacketing system for insulated pipe.

Insulated pipe jacketing generally refers to a sheet of metal surrounding an insulated pipe. Sheet metal jacketing is widely used on piping systems in refineries, power plants, and chemical facilities to protect the insulated pipe from mechanical, chemical, and electrical damage.

Typically, insulated piping and equipment components such as vessels and the like, are jacketed. Aluminum is commonly used, however, in certain situations, stainless steel, and in particular 300 series stainless steel, has been used to protect insulated pipe, vessels and components in, for example, liquid natural gas (LNG) installations and in locations near corrosive environments (salt water environments). However, 300 series stainless steel is expensive, both in initial cost as well as in maintenance and repair. Series 300 is used due to its high resistance to many corrosive materials. Other series of stainless steel are more susceptible to galvanic corrosion and local corrosion and thus are less frequently used. In certain environments, even the most durable stainless steel is susceptible to damage and corrosion, and as such the underlying insulation that the metal jacket protects can become corroded and fail, exposing the underlying pipe.

Accordingly, there is a need for an insulated pipe jacket that is durable and corrosion resistant. Desirably, such a durable metal jacket can be made of a wide variety of different grades or series of stainless steel. More desirably, such a jacket is readily made and usable, and has a high degree of integrity at reduced cost.

### BRIEF SUMMARY OF THE INVENTION

A polymer layered sheet metal jacket is used to protect insulated pipe from damage. In a present jacket, a layered damage protection system utilizes a sheet metal sandwiched between layers of polymeric material.

The layered protection system includes an interior layer of polymer, a rigid metal layer, and an outer polymeric protective coating. The interior polymer layer prevents corrosion from occurring on an inner surface of the jacket. The rigid metal layer provides mechanical strength to the system, and the external polymer layer protects against exterior mechanical, chemical, and electrical damage. The interior and exterior polymeric layers may or may not be formed from the same material.

A present jacket uses a stainless steel metal as the rigid metal layer. Preferably, a metal less expensive than 300 series metal, such as a 200 or 400 series stainless steel, is used, such that with the addition of the polymer jacket, the 200 or 400 series steel is enhanced by the polymer layers to the level of 304/316 (300 series) stainless steels. Other sheet metal materials may be used as additional protection is provided.

A present jacket's interior layer is made from a durable, non-porous, polymeric material and acts as a moisture retardant.

A present jacket's exterior layer is made from a polymeric material that is abrasion resistant, chemically inert to a broad range of chemicals, and resistant to fading, staining, or chipping. The exterior polymeric layer also reduces the likelihood of corrosion between adjacent jackets and prolongs equipment life.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a cross-sectional view of a layered sheet metal jacketing system;

FIG. 2 is a perspective view of a layered sheet metal jacketing system as applied to a section of piping;

FIG. 3 is an exploded illustration of a laminated structure of the present jacket;

FIG. 4 is a cross-sectional view of the jacket showing an outer higher grade stainless steel material affixed to an inner lower grade stainless steel material;

FIG. 5 is a cross-sectional view of an outer spiral wound layer of a higher grade stainless steel material on an inner lower grade stainless steel material; and

FIG. 6 is a cross-sectional view of a strap joint for the jacket.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

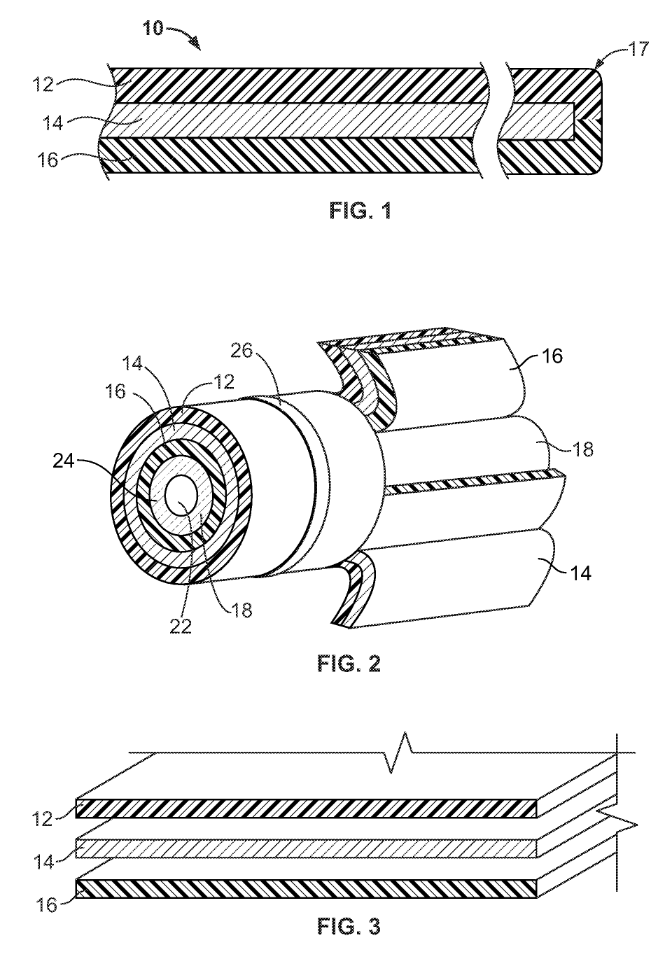

Referring now to the figures and in particular to FIG. 1, there is shown a cross-section of the layered jacket 10 of the present invention. The layered sheet-metal jacket 10 includes generally, an outer, polymeric layer 12, a middle structural layer 14, and an inner polymeric layer 16. The outer layer 12 and the inner layer 16 can be formed from the same material. However, it will be appreciated that the specific materials for the polymer layers 12, 16, should be selected based upon the application, e.g., environment, in which the jacketing 10 is used. For example, it may be that the jacketing is used on piping in a highly acidic environment, in which case the polymeric material (and in particular the outer layer 16 material) must be resistant to corrosion in highly acidic environments. It is also appreciated that minimizing and/or eliminating pin holes, thinned areas and the like is of extreme importance to prevent localized areas in which the underlying structural layer may be susceptible to attack. Likewise, if there any other environmental requirements and/or conditions, the outer layer should be selected based upon those requirements and/or conditions.

In a present jacket 10, a less expensive base material (e.g., 200 or 400 series stainless steel as opposed to a 300 series, such as 304 or 316 stainless steel, plain carbon steel, low alloy carbon steel, or any other material that is more susceptible to corrosion and less costly than 300 series stainless steel) is used in conjunction with the coatings 12, 16, to provide enhanced corrosion resistance.

A polymeric material such as a fluoropolymer is one suitable material. However, as discussed above, the specific material should be selected based upon various considerations including the chemical environment in which the jacket is used, the environs generally (whether it is used in an enclosed facility or outside and subject to weather conditions), the internal pipe temperature and the desired external jacket temperature.

Preferably, both polymeric materials adhere to the sheet metal 14. In addition, the outer layer 12 preferably is an abrasion resistant polymer, chemically inert to a broad range of chemicals, reduces corrosion between adjacent jackets, prolongs equipment life, and is resistant to fading, staining, chipping or chalking. The inner layer 16 is preferably a durable, non-porous, moisture retardant polymer. The inner layer is preferably of a material that is corrosion resistant and specifically resistant to corrosion from wet insulation, liquid and vapors from leaks in piping systems and components, and exterior (environmental) vapors.

Accordingly, the layers 12, 16 are applied as films, brushed, sprayed, dipped, powder coatings, plasma coating or by other methods that will be recognized by those skilled in the art. It is anticipated that structure of inner layer 12/structural layer 14/outer layer 16 will be laminate in that the layers will all be adhered to one another. In any event, a complete covering or coating of the structural layer 14 should be provided to assure that the integrity of that layer 14 is maintained and is not compromised. The layers 12, 16 and in particular, the inner layer 17 can also be applied as a paint or like coating.

It will be appreciated that the present jacket 10 allows the use of a lower cost structural (metal) layer 14 while maintaining the corrosion resistance of more expensive, chemically and environmentally corrosion-resistant materials. Accordingly, it will be understood that a wide variety of structural layer 14 materials can be used, although it is anticipated that a structural metal layer is used. Other suitable materials will be understood by those skilled in the art, and all such other materials are within the scope and spirit of the present invention.

In use, as seen in FIG. 2, sheet-metal jacket 10 encircles a pipe 22 having a layer of insulation 24, wrapped around a pipe 22. The insulation 24 fully surrounds the pipe 22, and the jacket 10 fully surrounds the insulation 24. The jacket 10 can be wrapped around the insulation 24 (generally with a light overlap) and a strap 26 can be wrapped around the jacket 10 to secure the jacket 10 to the pipe 22 and insulation 24. Other methods of fastening the jacket 10 to the insulation 24 and/or to itself (such as screws, rivets or other fasteners) can also be used.

The banding 26 can also be fabricated using a less expensive (200 or 400 series) material that is coated for corrosion resistance. Using a similar metal banding is encouraged to prevent any corrosion due to contact between dissimilar metals. The banding 26 can coated, painted, or treated as by any of the protective measured described herein.

It will be appreciated that the jacket 10 can be manufactured at a fabrication or other facility and field installed. The jacket 10 may be fabricated and rolled or cut to size in the field as required. In order to protect uncoated edges and the like, it is anticipated that a field applied inner and/or outer coating (12 and/or 16) may be used to provide protection for the jacket edges as well as the jacket surfaces. The field applied coating can be a spray coating, powder coating (with portable heating if necessary), foam coatings and the like.

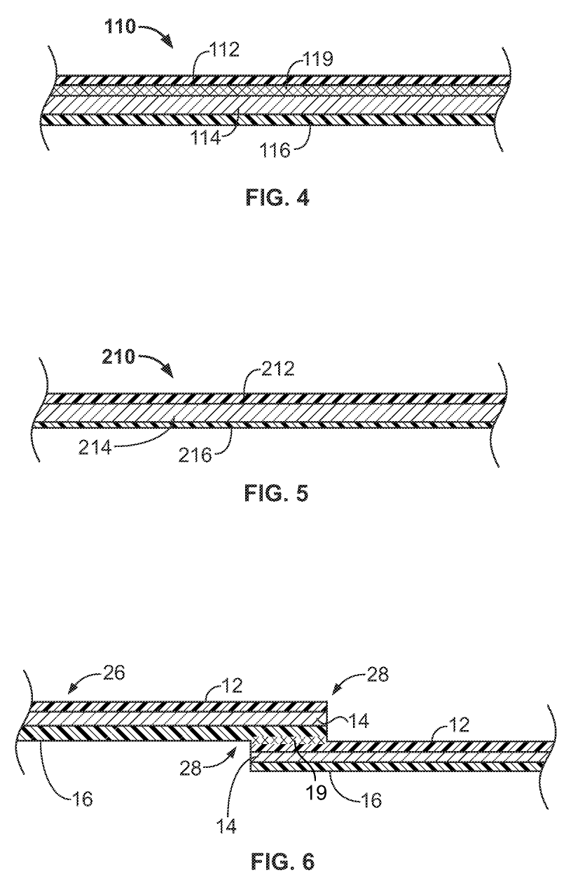

Referring to FIG. 4, other contemplated configurations for the jacket 110 include an outer layer 112 of thin (1 to 5 mil) higher grade (e.g., 304 or 316) stainless steel over a base 114 of lower grade stainless steel (200 or 400 series) with a polymeric coating 116 on the inside surface of the base material 114. The outer layer 112 can be applied over the base material layer 114 or, as see in FIG. 5, the outer layer 212 can be spiral wrapped over the inner layer 214. The inner layer 214 can include a polymer coating 216 for corrosion resistance.

Referring again to FIG. 4, the outer layer 112 can be affixed to the base material layer 114 by welding, adhesive or laminate/composite formation with, for example, a bonding polymer, as indicated generally at 119. It is also contemplated that the jacket 10 can be fabricated from passivated stainless steel.

As set forth above, the straps 26 can be formed in a manner similar to that of the jacket, by coating, lamination, electroplating or the like. In one form, as seen in FIG. 6, the ends 28 of the straps 26 can be joined to one another by fusing (indicated generally at 19) the polymer coating (12 and 16) on the strap ends 28, as by welding (the polymer) using a method similar to that used to weld or join plastic strapping material.

It is also envisioned that the edges E of the base or structural layer 14, 114, 214 can be coated (as at 17 in FIG. 1) to prevent the corrosion of the base material 14, 114, 214 from within (that is, from between the inner and outer layers). It will also be appreciated that the edge coating 17 can be pre-applied (e.g., as supplied) or can be field applied to accommodate installation needs as they arise, to provide additional protection to the underlying substrate 14, 114, 214.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A corrosion resistant jacket for insulated pipes comprising:
an outer polymeric layer;
an inner polymeric layer; and
a sheet metal layer disposed between the outer and the inner polymeric layers.

2. The jacket in accordance with claim 1 wherein the outer layer is a polymeric material laminated to the sheet metal layer.

3. The jacket in accordance with claim 2 wherein the outer layer is an abrasion resistant polymer, chemically inert to a broad range of chemicals, and resistant to fading, staining, chipping or chalking.

4. The jacket in accordance with claim 2 wherein the outer layer reduces corrosion between adjacent jackets.

5. The jacket of claim 1, wherein the inner layer is a polymeric material laminated to the sheet metal layer.

6. The jacket of claim 5 wherein the inner layer is a durable, non-porous polymer and is moisture retardant.

7. The jacket of claim 1, wherein the inner and outer layers are polymeric material laminated to the sheet metal layer.

8. The jacket of claim 7, wherein the polymeric material of the inner layer is different from the polymeric material of the outer layer.

9. The jacket of claim 1, wherein the sheet-metal is stainless steel.

10. The jacket of claim 9, wherein the stainless steel is 200 or 400 series stainless steel.

11. A corrosion resistant jacket for insulated pipe comprising:
an first stainless steel layer having a first thickness; and
a second stainless steel layer having a second thickness,
wherein the first stainless steel layer is disposed nearer to the pipe, and wherein the first stainless steel layer is fabricated from a 200 or a 400 series stainless steel and the second stainless steel layer is fabricated from a series of stainless steel other than 200 or 400 series stainless steel.

12. The corrosion resistant jacket in accordance with claim 11 wherein the second stainless steel layer is fabricated from a 300 series stainless steel.

13. The corrosion resistant jacket in accordance with claim 12 wherein the first thickness is greater than the second thickness.

14. The corrosion resistant jacket in accordance with claim 13 wherein the first and second layers are bonded to one another.

15. The corrosion resistant jacket in accordance with claim 11 wherein the second stainless steel layer is wound around the first stainless steel layer.

16. A method of making a durable sheet metal jacketed insulated pipe comprising the steps of:
forming a durable, sheet metal jacket by coating an inner surface of a sheet metal with a first polymeric material;
coating an outer surface of the sheet metal with a second polymeric material;
forming an insulated pipe by wrapping an insulating material around an exterior surface of a pipe; and
wrapping the durable sheet metal jacket around an exterior of the insulated pipe, such that the first polymeric material of the sheet metal jacket is adjacent to the exterior surface of the insulated pipe.

17. The method of making a corrosion resistant sheet metal jacket as recited in claim 16 wherein the coating of the inner surface of sheet metal is performed by laminating layers of the polymer onto the inner surface of the sheet metal.

18. The method of making a corrosion resistant sheet metal jacket as recited in claim 16 wherein the coating of the outer surface of sheet metal is performed by laminating layers of the polymer onto the outer surface of the sheet metal.
